(19) United States
(12) Patent Application Publication
(10) Pub. No.: US 2021/0092282 A1
(43) Pub. Date: Mar. 25, 2021

(54) CONTROL DEVICE AND CONTROL METHOD

(71) Applicant: SZ DJI TECHNOLOGY CO., LTD., Shenzhen (CN)

(72) Inventors: Tomonaga YASUDA, Tokyo (JP); Kenichi HONJO, Tokyo (JP)

(21) Appl. No.: 17/115,671

(22) Filed: Dec. 8, 2020

Related U.S. Application Data
(63) Continuation of application No. PCT/CN2019/091734, filed on Jun. 18, 2019.

(30) Foreign Application Priority Data
Jun. 19, 2018 (JP) 2018-116446

(51) Int. Cl. H04N 5/232; B64C 39/02; B64D 47/08; G05D 1/10; H04N 7/18

(52) U.S. Cl. CPC H04N 5/23218; B64C 39/024; B64D 47/08; B64C 2201/127; H04N 5/232127; H04N 5/23206; H04N 7/181; G05D 1/102

(57) ABSTRACT

Control device, movable object, control method and program are provided. The control device includes a memory and a processor coupled to the memory. The processor is configured to: acquire first resolution information of a resolution of a camera device mounted on a movable object; determine a first geographic area according to the first resolution information; and control the movable object or the camera device, to prevent at least one of: the camera device from photographing in the first geographic area, or an image photographed by the camera device in the first geographic area from being stored.

### CROSS-REFERENCES TO RELATED APPLICATIONS

This application is a continuation application of International Patent Application No. PCT/CN2019/091734, filed on Jun. 18, 2019, which claims priority to Japanese Patent Application No. 2018-116446, filed on Jun. 19, 2018, the entire contents of which are hereby incorporated by reference.

### FIELD OF THE DISCLOSURE

The present disclosure generally relates to the field of unmanned aerial vehicle (UAV), and, more particularly, relates to a control device and a control method.

### BACKGROUND

Japanese patent No. 4396245 discloses a technique that a mobile communication terminal with a photographing function is restricted to perform an operation/movement related to the photographing function in an operation restriction area. There is a need to change a restricted area where movements of the camera device or a movable object are restricted according to a resolution of the camera device mounted on the movable object.

### BRIEF SUMMARY OF THE DISCLOSURE

One aspect of the present disclosure provides a control device. The control device includes a memory and a processor coupled to the memory. The processor is configured to: acquire first resolution information of a resolution of a camera device mounted on a movable object; determine a first geographic area according to the first resolution information; and control the movable object or the camera device, to prevent at least one of: the camera device from photographing in the first geographic area, or an image photographed by the camera device in the first geographic area from being stored.

Another aspect of the present disclosure provides a control method. The control method includes: acquiring first resolution information of a resolution of a camera device mounted on a movable object; determining a first geographic area according to the first resolution information; and controlling the movable object or the camera device, to prevent at least one of: the camera device from photographing in the first geographic area, or an image photographed by the camera device in the first geographic area from being stored.

Other aspects or embodiments of the present disclosure can be understood by those skilled in the art in light of the description, the claims, and the drawings of the present disclosure.

### BRIEF DESCRIPTION OF THE DRAWINGS

FIG. 1 illustrates a schematic diagram of an exemplary appearance of an unmanned aerial vehicle (UAV) and a remote operation device consistent with various disclosed embodiments of the present disclosure;

FIG. 2 illustrates a schematic diagram of exemplary functional blocks of an UAV consistent with various disclosed embodiments of the present disclosure;

FIG. 3 illustrates a schematic diagram of an exemplary geographic area consistent with various disclosed embodiments of the present disclosure;

FIG. 4 illustrates a schematic diagram of another exemplary geographic area consistent with various disclosed embodiments of the present disclosure;

FIG. 5 illustrates a schematic diagram of another exemplary geographic area consistent with various disclosed embodiments of the present disclosure;

FIG. 6 illustrates a schematic diagram of another exemplary geographic area consistent with various disclosed embodiments of the present disclosure;

FIG. 7 illustrates a schematic diagram of another exemplary geographic area consistent with various disclosed embodiments of the present disclosure;

FIG. 8 illustrates a schematic diagram of another exemplary geographic area consistent with various disclosed embodiments of the present disclosure;

FIG. 9 illustrates a flowchart of an exemplary procedure of controlling a camera device and a UAV based on a resolution of the camera device consistent with various disclosed embodiments of the present disclosure; and

FIG. 10 illustrates a schematic diagram of an exemplary hardware configuration consistent with various disclosed embodiments of the present disclosure.

Reference Numeral List: UAV 10; UAV body 20; UAV controller 30; memory 32; communication interface 36; propulsion unit 40; GPS receiver 41; inertial measurement unit 42; magnetic compass 43; barometric altimeter 44; temperature sensor 45; humidity sensor 46; universal joint 50, camera devices 60; camera apparatus 100; photographing unit 102; photographing controller 110; acquisition circuit 112; exporting circuit 114; restriction circuit 116; image sensor 120; memory 130; lens unit 200; lens 210; lens driver 212; position sensor 214; lens controller 220; memory 222; remote operation device 300; display 310; map 400; object 450; geographic area 500, 510, 520, 530; no-fly zone 600; photographing range 700; computer 1200; host controller 1210; CPU 1212; RAM 1214; input/output controller 1220; communication interface 1222; and ROM 1230.

### DETAILED DESCRIPTION

The present disclosure is described by following embodiments of the present disclosure, but the following embodiments do not limit the present disclosure covered by claims. In addition, not all combinations of features described in the embodiments are necessary for solutions of the present disclosure. Those skilled in the art can make various changes or improvements to the following embodiments. It is obvious from a description of the claims that the various changes or improvements can be included in the technical scope of the present disclosure.

Claims, specification, accompanying drawings and abstract of the specification contain matters that are protected by copyrights. If anyone makes copies of the above files as indicated in patent office's documents or records, the copyright owner cannot object. However, in other cases, all the copyrights are reserved.

Various embodiments of the present disclosure can be described with reference to flowcharts and block diagrams. A box can represent (1) a process stage of performing an operation or (2) a device “part” that performs the operation. Specific stages and “parts” can be implemented by programmable circuits and/or processors. Dedicated circuits may include digital and/or analog hardware circuits, integrated circuits (IC) and/or discrete circuits. Programmable circuits can include reconfigurable hardware circuits. The reconfigurable hardware circuits can include AND logic, OR logic, XOR logic, NAND logic, NOR logic, other logical operations, and other memory components such as flip-flop, register, field programmable gate array (FPGA), programmable logic array (PLA), etc.

A computer-readable medium may include any tangible device that stores instructions to be executed by a suitable device. The computer-readable medium having instructions stored therein includes a product including instructions. The instructions can be executed to create a means for performing operations specified in the flowchart or block diagrams. Exemplarily, the computer-readable medium may include electronic storage media, magnetic storage media, optical storage media, electromagnetic storage media, semiconductor storage media, etc. More specifically, the computer-readable medium may include floppy disk (registered trademark), hard disk, random access memory (RAM), read only memory (ROM), erasable programmable read only memory (EPROM or flash memory), electrically erasable programmable read only memory (EEPROM), static random access memory (SRAM), compact disc read-only memory (CD-ROM), digital versatile disc (DVD), Blu-ray disc (BD), memory stick, integrated circuit card, etc.

A computer-readable instruction may include any one of source codes or object codes described in any combination of one or more programming languages. The source codes or object codes include traditional procedural programming languages. Traditional programming languages can be assembly instructions, instruction set architecture (ISA) instructions, machine instructions, machine-related instructions, microcode, firmware instructions, status setting data, or Smalltalk, JAVA (registered trademark), object programming language such as C++ or the like, “C” programming language or similar programming language. The computer-readable instructions can be provided locally or via a wide area network (WAN) such as a local area network (LAN) or the internet to a processor or programmable circuit of a general-purpose computer, a special-purpose computer, or other programmable data processing device. A processor or programmable circuit can execute computer-readable instructions to create means for performing operations specified in a flowchart or block diagram. Exemplarily, the process includes computer processor, processing unit, microprocessor, digital signal processor, controller, microcontroller, etc.

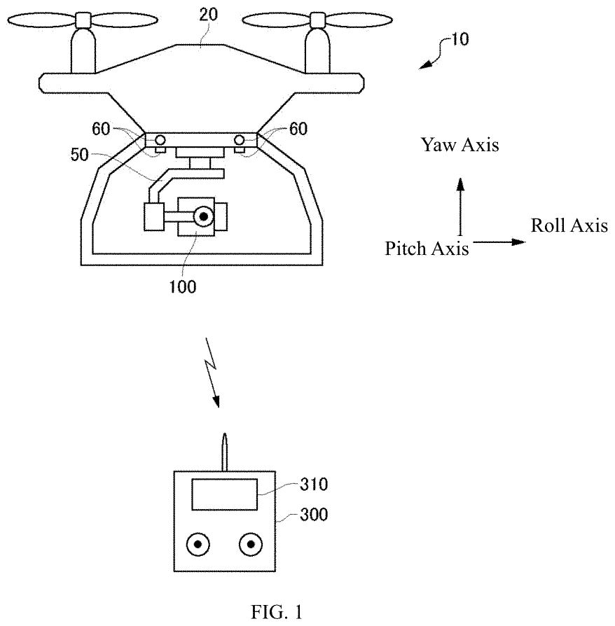

FIG. 1 illustrates a schematic diagram of an exemplary appearance of an unmanned aerial vehicle (UAV) 10 and a remote operation device 30 consistent with various disclosed embodiments of the present disclosure. The UAV 10 includes a UAV body 20, a universal joint 50, a plurality of camera devices 60, and a camera apparatus 100. The universal joint 50 and the camera apparatus 100 constitute an exemplary photographing system. The UAV 10 is an exemplary movable object. The movable object refers to a flying body moving in the air, a vehicle moving on the ground, a ship moving on the water, etc. The flying body moving in the air refers to not only UAV, but also other aircraft, airship, helicopter or the like that moves in the air.

The UAV body 20 includes a plurality of rotors. The plurality of rotors constitute an exemplary propulsion unit. The UAV body 20 makes the UAV 10 fly by controlling rotations of the plurality of rotors. For example, the UAV body 20 uses four rotors to make the UAV 10 fly. The number of rotors is not limited to four. In addition, The UAV 10 can also be a fixed-wing aircraft without rotors.

The camera apparatus 100 is a photographing camera for photographing an object included in a desired photographing range. The universal joint 50 is configured to support the camera device rotatably. The universal joint 50 is one exemplary supporting mechanism. For example, the universal joint 50 uses an actuator to rotatably support the camera apparatus 100 around a pitch axis so that the camera device is rotatable around the pitch axis. The universal joint 50 may further use the actuator to rotatably support the camera apparatus 100 around a roll axis and a yaw axis, respectively. The universal joint 50 can change a posture of the camera apparatus 100 by rotating the camera apparatus 100 about at least one of the yaw axis, the pitch axis, or the roll axis.

The plurality of camera devices 60 are sensing cameras configured to photograph surroundings of the UAV 10 to control flights of the UAV 10. Two camera devices 60 can be disposed on a nose of UAV 10, that is, a front surface. The other two camera devices 60 can be disposed on a bottom surface of UAV 10. The two camera devices 60 on the front surface can be paired to function as a stereo camera. The two camera devices 60 on the bottom surface can also be paired to function as a stereo camera. The camera device 60 can detect a presence of an object included in the photographing range of the camera device 60 and measure a distance from the camera device 60 to the object. The camera device 60 is an exemplary measuring device that measures an object existing in a photographing direction of the camera apparatus 100. The measuring device may also be other sensors such as infrared sensors and ultrasonic sensors that measure the object existing in the photographing direction of the camera apparatus 100. Three-dimensional spatial data around the UAV 10 can be generated based on one or more images photographed by the plurality of camera devices 60. The number of the camera devices 60 included in the UAV 10 is not limited to four. The UAV 10 includes at least one camera device 60. The UAV 10 can also include at least one camera device 60 on a nose, a tail, a side, a bottom and a top of the UAV 10, respectively. A viewing angle that can be set in the camera device 60 may be greater than a viewing angle that can be set in the camera apparatus 100. The camera device 60 may also have a single focus lens or a fisheye lens.

A remote operation device 300 communicates with the UAV 10 to remotely operate the UAV 10. The remote operation device 300 may communicate wirelessly with the UAV 10. The remote operation device 300 may include a display 310 that displays various information related to the UAV 10. The remote operation device 300 sends to the UAV 10 instruction information indicating various instructions related to movements of the UAV 10, such as ascending, descending, accelerating, decelerating, forwarding, reversing, rotating, etc. For example, the instruction information includes instruction information for raising an altitude of the UAV 10. The indication information can indicate an altitude where UAV 10 should be located. The UAV 10 moves to be at the altitude indicated by the instruction information received from the remote operation device 300. The instruction information may include an ascending instruction to raise the UAV 10. The UAV 10 rises while receiving the ascending instruction. When the altitude of UAV 10 reaches an upper limit, UAV 10 can limit an ascent even if the ascending instruction is accepted.

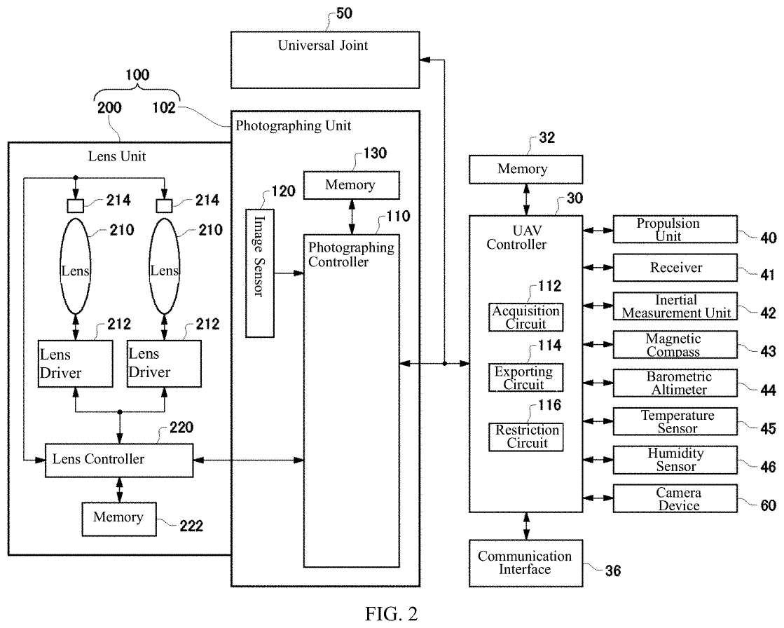

FIG. 2 illustrates a schematic diagram of exemplary functional blocks of an UAV consistent with various disclosed embodiments of the present disclosure. The UAV 10 includes a UAV controller 30, a memory 32, a communication interface 36, a propulsion unit 40, a GPS receiver 41, an inertial measurement unit 42, a magnetic compass 43, a barometric altimeter 44, a temperature sensor 45, a humidity sensor 46, a universal joint 50, a plurality of camera devices 60 and a camera apparatus 100.

The communication interface 36 communicates with other devices such as the remote operation device 300. The communication interface 36 can receive instruction information including various instructions to the UAV controller 30 from the remote operation device 300. The memory 32 stores programs and the like necessary for the UAV controller 30 to control the propulsion unit 40, the GPS receiver 41, the inertial measurement unit (IMU) 42, the magnetic compass 43, the barometric altimeter 44, the temperature sensor 45, the humidity sensor 46, the universal joint 50, the plurality of camera devices 60, and the camera apparatus 100. The memory 32 may be a computer-readable recording medium including at least one of flash memories including SRAM, DRAM, EPROM, EEPROM, USB memory and the like. The memory 32 may be disposed inside the UAV body 20. It can be set to be detachable from the UAV body 20.

The UAV controller 30 controls flights and photographing of the UAV 10 according to the program stored in the memory 32. The UAV controller 30 may be composed of a microprocessor such as a CPU or Microprocessor Unit (MPU), and a microcontroller such as a microcontroller unit (MCU). The UAV controller 30 controls the flights and the photographing of the UAV 10 in accordance with instructions received from the remote operation device 300 via the communication interface 36. The propulsion unit 40 has a plurality of rotors and a plurality of drive motors that rotate the plurality of rotors. The propulsion unit 40 rotates the plurality of rotors via the plurality of drive motors in accordance with instructions from the UAV controller 30 to make the UAV 10 fly.

The GPS receiver 41 receives a plurality of signals representing the time transmitted from a plurality of GPS satellites. The GPS receiver 41 calculates a position (a latitude and a longitude) of the GPS receiver 41, that is, a position (a latitude and a longitude) of the UAV 10 based on a plurality of received signals. IMU 42 detects a posture of the UAV 10. The IMU 42 detects an acceleration of the UAV 10 in three-axis directions of front and rear, left and right, and up and down, and the angular velocities of the UAV 10 in three-axis directions of the pitch axis, the roll axis, and the yaw axis as the posture of the UAV 10. The magnetic compass 43 detects an orientation of the nose of the UAV 10. The barometric altimeter 44 detects a flying altitude of the UAV 10. The barometric altimeter 44 detects an air pressure around the UAV 10 and converts the detected air pressure to altitude, so as to detect the altitude of the UAV 10.

The camera apparatus 100 includes a photographing unit 102 and a lens unit 200. The lens unit 200 is an exemplary lens device. The photographing unit 102 has an image sensor 120, a photographing controller 110, and a memory 130. The image sensor 120 may be composed of a CCD or a CMOS. The image sensor 120 photographs optical images formed through a plurality of lenses 210 and outputs the photographed image data to the photographing controller 110. The photographing controller 110 may be constituted by a microprocessor such as a CPU, an MPU, or the like, and a microcontroller such as an MCU, or the like. The photographing controller 110 may control the camera apparatus 100 according to an operation instruction of the camera apparatus 100 from the UAV controller 30. The memory 130 may be a computer-readable recording medium, and may include at least one of flash memories including SRAM, DRAM, EPROM, EEPROM, USB memory, and the like. The memory 130 stores programs and the like necessary for the photographing controller 110 to control the image sensor 120 etc. The memory 130 may be disposed inside a housing of the camera apparatus 100. The memory 130 may be configured to be detachable from a housing of the camera apparatus 100.

The lens unit 200 includes one or more lenses 210, one or more lens drivers 212, and a lens controller 220. The one or more lenses 210 can function as a zoom lens, a varifocal lens, and a focusing lens. At least part or all of the one or more lenses 210 are configured to be able to move along the optical axis. The lens unit 200 may include an interchangeable lens that is configured to be detachable from the photographing unit 102. The lens driver 212 moves at least part or all of the one or more lenses 210 along an optical axis via a mechanism such as a cam ring. The lens driver 212 may include an actuator. The actuator can include a stepper motor. The lens controller 220 drives the one or more lens driver 212 in accordance with lens control instructions from the photographing unit 102 to move one or more lenses 210 in an optical axis direction via a mechanism member. For example, the lens control instructions are zoom control instructions and focus control instructions.

The lens unit 200 also includes a memory 222 and a position sensor 214. The lens controller 220 controls movements of the lens 210 in the optical axis direction via the lens drive unit 212 in accordance with a lens operation instruction from the photographing unit 102. Part or all of the lenses 210 move along the optical axis. The lens controller 220 performs at least one of a zooming action and a focusing action by moving at least one of the lenses 210 along the optical axis. The position sensor 214 detects the position of the lens 210. The position sensor 214 may detect a current zoom position or focus position.

The lens driver 212 may include a shake correction mechanism. The lens controller 220 may move the lens 210 in a direction along the optical axis or a direction perpendicular to the optical axis via the shake correction mechanism to perform a shake correction. The lens driver 212 may drive the shake correction mechanism by a stepper motor to perform the shake correction. The shake correction mechanism may be driven by the stepper motor to move the image sensor 120 in the direction along the optical axis or the direction perpendicular to the optical axis to perform the shake correction.

The memory 222 stores control values of the one or more lenses 210 that are movable by the one or more lens drivers 212. The memory 222 may include at least one of flash memories such as SRAM, DRAM, EPROM, EEPROM, USB memory and the like.

For the camera apparatus 100 mounted on the UAV 10 as described above, photographing of the camera apparatus 100 may be restricted at an area in a flight range of the UAV 10. On the other hand, a resolution of the camera apparatus 100 varies according to a focal length of the camera apparatus 100, a zoom magnification (e.g., zoom ratio), a pixel pitch of the image sensor 120, etc. For example, an area that does not restrict photographing of the camera apparatus 100 with a relatively low resolution may sometimes include an area that restricts photographing of the camera apparatus 100 with a relatively high resolution. That is, depending on the resolution of the camera apparatus 100, an area where the camera apparatus 100 is allowed to photograph and an area where the UAV 10 is allowed to fly may be different. In one embodiment, according to the resolution of the camera apparatus 100, an area where the camera 100 is allowed to photograph, an area where an image photographed by the camera 100 can be stored, and/or an area where the UAV 10 can fly can be set.

The UAV controller 30 includes an acquisition circuit 112, an exporting circuit 114, and a restriction circuit 116. In some embodiments, the acquisition circuit 112, the exporting circuit 114, and the restriction circuit 116 may be disposed on a device other than the UAV controller 30. The photographing controller 110 or the remote operation device 300 may also include the acquisition circuit 112, the exporting circuit 114, and the restriction circuit 116.

The acquisition circuit 112 acquires resolution information indicating the resolution of the camera apparatus 100. The resolution is an index indicating an image quality of an image photographed by the camera apparatus 100. For example, the resolution may be a contrast between a white part and a black part of the image when black lines drawn in parallel and equally spaced on a white background are imaged on a photographing surface using an optical system. The resolution depends on a focal length of the lens unit 200, a zoom magnification of the lens unit 200, an optical characteristic of the lens unit 200, and a pixel pitch of the image sensor 120, etc. Therefore, the resolution information acquired by the acquisition circuit 112 can include at least one of: identification information of the camera apparatus 100, identification information of the lens unit 200, the focal length of the lens unit 200, the zoom magnification of the lens unit 200, or identification information of the image sensor 120. The acquisition circuit 112 can acquire at least one of the identification information of the camera apparatus 100, the identification information of the lens unit 200, the focal length of the lens unit 200, the zoom magnification of the lens unit 200, or the identification information of the image sensor 120 stored in the memory 222 or the memory 130 as the resolution information.

The exporting circuit 114 exports a geographic area according to the resolution information. Export, as used herein, may refer to determine and output (e.g., output to the restriction circuit 116, the display 310, etc.). The geographic area can be defined by a latitude and a longitude. The geographic area can be defined by the latitude, the longitude, and an altitude. The restriction circuit 116 controls the UAV 10 or the camera apparatus 100, so as to prevent the camera apparatus 100 from photographing in the geographic area or to prevent an image photographed by the camera apparatus 100 in the first geographic area from being stored. The restriction circuit 116 is an example part of the controller. The restriction circuit 116 may control the UAV 10 so that the UAV 10 cannot enter the geographic area. When the camera apparatus 100 includes a zoom function, the restriction circuit 116 may control the camera apparatus 100 so as to restrict a range of zoom magnification that can be used for the camera apparatus 100 in the geographic area.

The acquisition circuit 112 can acquire object information including a geographic location of an object. The exporting circuit 114 may export the geographic area according to the resolution information and the object information. The exporting circuit 114 may export the geographic area including the object. The exporting circuit 114 may export the geographic area that does not include the object. The geographic location of the object can be defined by latitude and longitude. The geographic location of the object can be defined by the latitude and the longitude. The geographic location of the object can be defined by the latitude, the longitude, and the altitude.

The acquisition circuit 112 can acquire a geographic location of the camera apparatus 100 and a photographing direction of the camera apparatus 100 in the geographic location. The acquisition circuit 112 may acquire a current geographic location of the UAV 10 as the geographic location of the camera apparatus 100. The geographic location of the camera apparatus 100 can be defined by a latitude and a longitude. The geographic location of the camera apparatus 100 can be defined by the latitude, the longitude and the altitude.

According to the geographic location of the camera apparatus 100 and the photographing direction relative to the geographic location of the camera apparatus 100, the restriction circuit 116 can control the UAV 10 or the camera apparatus 100 to prevent the camera apparatus 100 from photographing the object in a geographic area and/or prevent an image including the object photographed by the camera apparatus 100 in the geographic area from being stored.

When a resolution of the camera device mounted on the moving body is changed, the acquisition circuit 112 may further acquire other resolution information indicating the resolution of the camera device after change. The exporting circuit 114 may export other geographic areas according to the other resolution information. The restriction circuit 116 may control the UAV 10 or the camera apparatus 100 to prevent the camera apparatus 100 from photographing in other geographic areas and/or to prevent an image photographed by the camera apparatus 100 in the other geographic area from being stored.

When the camera device includes the zoom function, the acquisition circuit 112 may acquire a first zoom magnification of the lens unit 200 as first resolution information. When the first zoom magnification of the lens unit 200 is changed to a second zoom magnification, the acquisition circuit 112 may acquire the second zoom magnification as second resolution information. The exporting circuit 114 may export the first geographic area according to the first zoom magnification. The exporting circuit 114 may export the second geographic area according to the second zoom magnification.

A geographic area exported by the exporting circuit 114 can be displayed on the display 310 and the like included in the remote operation device 300. The display 310 of the remote operation device 300 can display the geographic area and the current geographic location of the UAV 10 on a map.

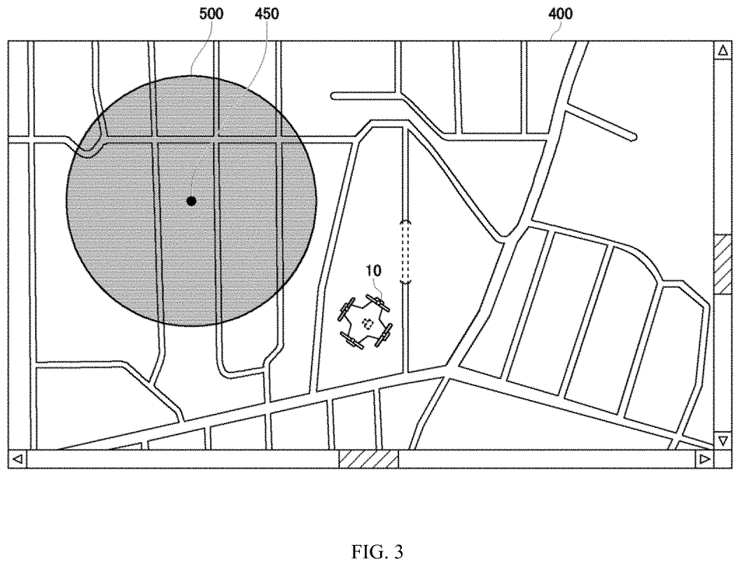

FIGS. 3-7 illustrate schematic diagrams of an exemplary geographic area consistent with various disclosed embodiments of the present disclosure. As shown in FIG. 3, the display 310 superimposes and displays on a map 400 the current geographic location of the UAV 10, an object 450 as a photographing restriction object, and a geographic area 500 of photographing restriction. For example, when the zoom magnification of the lens unit 200 of the camera apparatus 100 mounted on the UAV 10 is one time (e.g., less than a reference magnification/ratio, such as 2.0), the resolution of the camera apparatus 100 is smaller than a threshold of the photographing restriction object. When the zoom magnification of the lens unit 200 of the camera apparatus 100 mounted on the UAV 10 is two times (e.g., equals the reference magnification, such as 2.0), the resolution of the camera apparatus 100 is greater than or equal to the threshold of the photographing restriction object. When the zoom magnification of the lens unit 200 is set to be two times or more, the geographic area 500 of photographing restriction is set, and the restriction circuit 116 controls a flight of the UAV 10 to prevent the UAV 10 from entering the geographic area 500. When the UAV 10 flies within the geographic area 500, the restriction circuit 116 prevents the camera apparatus 100 from photographing and/or prevents an image photographed by the camera apparatus 100 from being stored.

On the other hand, when the zoom magnification of the lens unit 200 is less than two times (i.e., less than the reference magnification 2.0), the restriction circuit 116 controls the UAV 10 and the camera apparatus 100 so that the UAV 10 may fly in the geographic area 500 and the camera apparatus 100 may photograph. In addition, for example, the zoom magnification of the lens unit 200 is one time, and when the UAV 10 flies within the geographic area 500, a user uses the remote operation device 300 to change the zoom magnification of the lens unit 200 to two times. The restriction circuit 116 may control the camera apparatus 100 so that the zoom magnification of the lens unit 200 cannot be changed to two times within the geographic area 500. Or, when an instruction to change the zoom magnification to 2 times is received from the remote operation device 300, the restriction circuit 116 may control the UAV 10 so that the UAV 10 moves outside the geographic area 500. Corresponding to the UAV 10 moving outside the geographic area 500, the restriction circuit 116 may control the camera apparatus 100 to change the zoom magnification to two times.

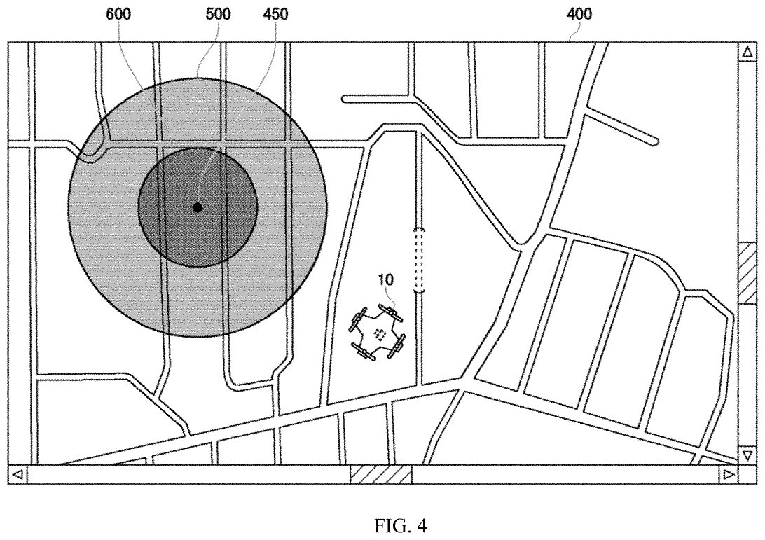

As shown in FIG. 4, except the geographical area 500 where photographing is restricted, the display 310 can superimpose a no-fly zone 600 in which the UAV 10 is prohibited from flying on the map 400 regardless of the resolution of the camera apparatus 100. The no-fly zone 600 may be an area preset by a public institution or the like. The restriction circuit 116 controls the UAV 10 so that the UAV 10 cannot fly in the no-fly zone 600. On the other hand, if a current resolution of the camera apparatus 100 is greater than or equal to a threshold (i.e., a current zoom magnification is greater than or equal to a reference magnification), the restriction circuit 116 controls the UAV 10 so that the UAV 10 cannot fly within the geographic area 500. Or the restriction circuit 116 controls the camera apparatus 100 so that the camera apparatus 100 cannot photograph an image within the geographic area 500 or cannot store the photographed image. If the current resolution of the camera apparatus 100 is less than the threshold, the restriction circuit 116 controls the UAV 10 and the camera apparatus 100 so that the UAV 10 can fly in the geographic area 500 and the camera apparatus 100 can photograph in the geographic area 500.

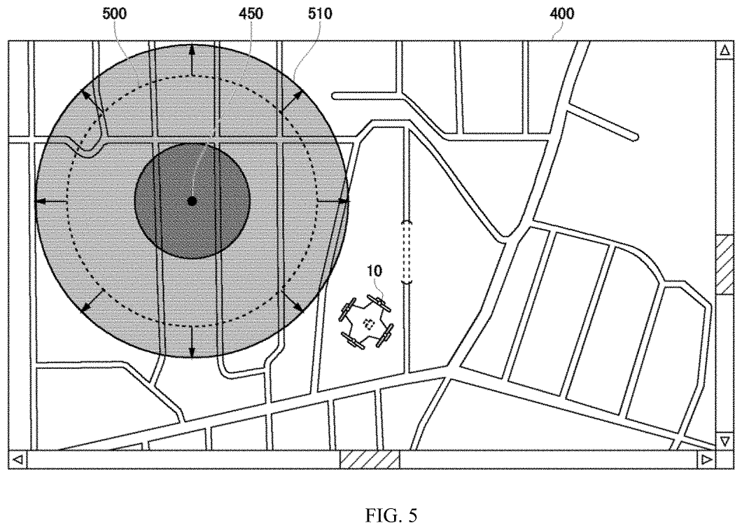

As a photographing parameter such as a zoom magnification of the camera apparatus 100 changes, the resolution of the camera apparatus 100 changes. The exporting circuit 114 changes a size, a shape, and the like of the geographic area 500 according to a change of the resolution of the camera apparatus 100. For example, if the resolution of the camera apparatus 100 changes from a first resolution to a second resolution, as shown in FIG. 5, a geographic area displayed by the display 310 changes from the geographic area 500 to a geographic area 510. For another example, if the zoom magnification of the camera apparatus 100 is changed from one time to two times, a geographical area restricted to be photographed by the camera apparatus 100 changes from the geographical area 500 to the geographical area 510.

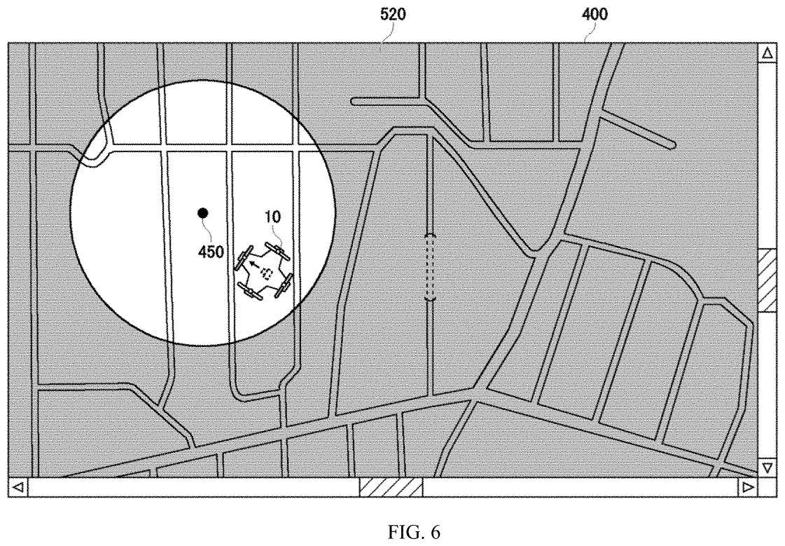

The above example explains that the object 450 as the photographing restriction object is included in the geographic area 500. However, as shown in FIG. 6, the object 450 as the photographing restriction object, may not be included in a geographical area 520 of photographing restriction of the camera apparatus 100. In an example shown in FIG. 6, in an area including the object 450 surrounded by the geographic area 520, the restriction circuit 116 controls the UAV 10 and the camera apparatus 100 so that the UAV 10 may fly and the camera apparatus 100 may photograph. In some embodiments, the restriction circuit 116 may prevent the camera from photographing outside the geographic area 520, and/or prevent an image photographed in the geographic area 520 being stored.

For example, sometimes it is desired (e.g., by a user) to allow photographing the object 450, but disallow an image to include information that can specify a location of the object 450. For another example, sometimes the camera apparatus 100 is not allowed to photograph an image that includes both landmarks and the objects 450 that can specify the location of the object 450. In addition, the camera apparatus 100 is sometimes allowed to photograph an image that includes part of the object 450, but the camera apparatus 100 is not allowed to photograph an image that includes the entire object 450. In the above-described scenarios and any other similar or proper scenarios, the exporting circuit 114 may export the geographic area 520 that restricts photographing of the camera apparatus 100 so that the object 450 as a photographing restriction object is not included in the geographic area 520.

The restriction circuit 116 may further control the camera apparatus 100 according to a photographing direction (e.g., direction range) of the camera apparatus 100, so that the camera apparatus 100 may not photograph in a geographic area or may not store a photographed image. According to a current geographic location of the camera apparatus 100, the photographing direction of the camera apparatus 100 and a viewing angle of the camera apparatus 100, the restriction circuit 116 can control the camera apparatus 100 or the UAV 10, so that the camera apparatus 100 may not photograph or store an image including a photographing restriction object.

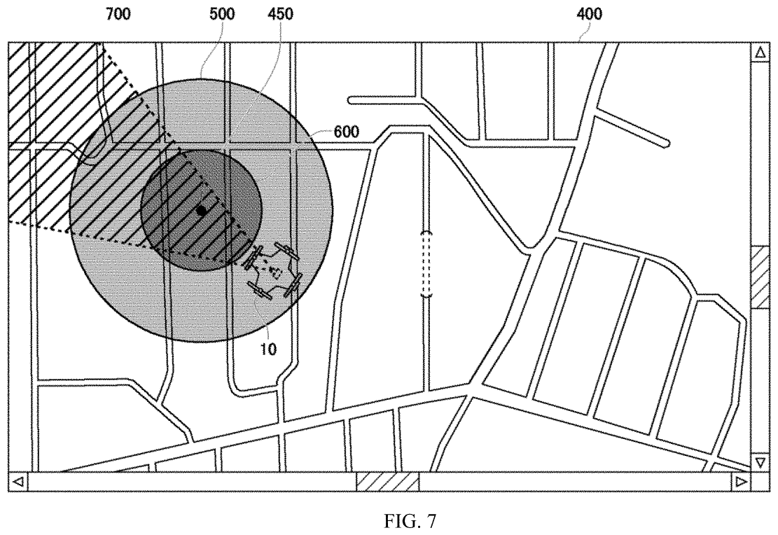

As shown in FIG. 7, according to the current geographic location of the camera apparatus 100, the photographing direction of the camera apparatus 100, and the viewing angle of the camera apparatus 100, the restriction circuit 116 can specify a photographing range 700 of the camera apparatus 100. When the photographing range 700 includes the object 450, the restriction circuit 116 may control the camera apparatus 100 so that the camera apparatus 100 may not photograph or store an image including the object 450.

For example, the geographic area 500 is an area where the camera apparatus 100 is prohibited from photographing when a zoom magnification of the lens unit 200 is two times or more. Even when the UAV 10 flies within the geographic area 500 and the zoom magnification of the lens unit 200 is two times or more, if the object 450 is not included in the photographing range 700 of the camera device 10, the restriction circuit 116 may also control the camera apparatus 100 and the UAV 10 so that the camera apparatus 100 can perform photographing.

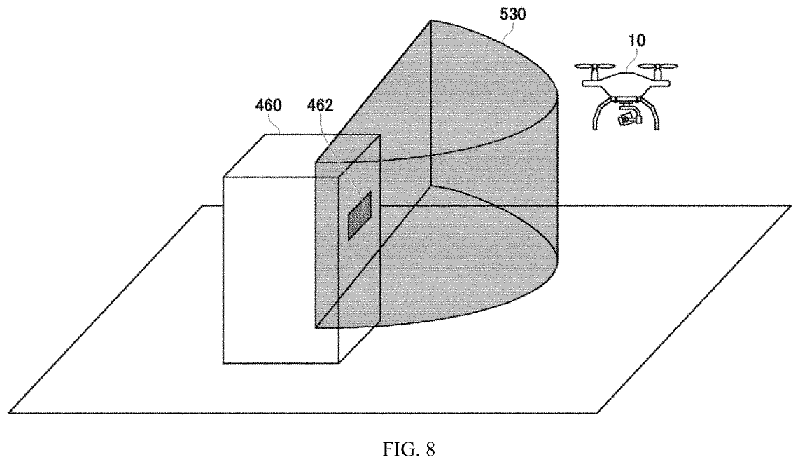

According to an altitude of the camera apparatus 100, the restriction circuit 116 may further control the camera apparatus 100 or the UAV 10, so that the camera apparatus 100 may not photograph or store an image including a photographing restriction object. For example, as shown in FIG. 8, when it is not allowed to photograph a partial area 462 of a building 460 with a resolution greater than or equal to a preset value, according to a latitude, a longitude and an altitude of the camera apparatus 100, the restriction circuit 116 may determine whether the camera apparatus 100 is allowed to photograph. The restriction circuit 116 may control the camera apparatus 100 and the UAV 10 so that the camera apparatus 100 cannot photograph or store an image with a resolution equal to or greater than the preset value within the geographic area 530 defined by the latitude, the longitude, and the altitude of the camera apparatus 100 exported by the exporting circuit 114.

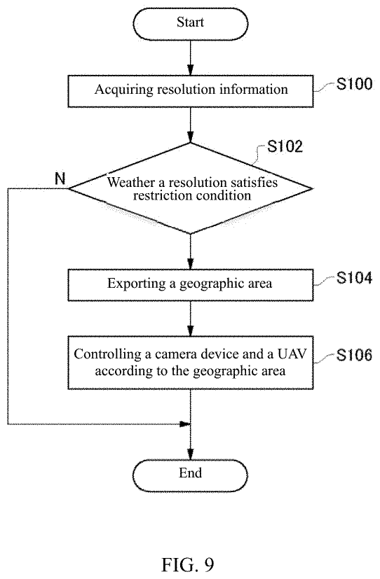

FIG. 9 illustrates a flowchart of an exemplary control procedure of the camera apparatus 100 and the UAV 10 based on the resolution of the camera apparatus 100 consistent with various disclosed embodiments of the present disclosure. The control steps shown in FIG. 9 can be executed in sequence before a flight of the UAV 10 starts and after a setting of the zoom magnification of the camera apparatus 100 is changed.

The acquisition circuit 112 acquires resolution information from the memory 222 of the lens unit 200 or the memory 130 of the photographing unit 102 (S100). For example, the acquisition circuit 112 may acquire information indicating a current zoom magnification of the lens unit 200 as the resolution information. The exporting circuit 114 determines whether the current resolution of the camera apparatus 100 satisfies a preset restriction condition (S102). The exporting circuit 114 can determine whether the current resolution of the camera apparatus 100 is greater than or equal to a preset threshold. The exporting circuit 114 can determine whether the zoom magnification of the camera apparatus 100 is greater than or equal to a preset reference zoom magnification determined according to the optical characteristics of the camera apparatus 100.

If the current resolution of the camera apparatus 100 does not meet the preset restriction condition, the restriction circuit 116 may control the camera apparatus 100 within the area where the UAV 10 can fly, so that the camera apparatus 100 may photograph without restricting photographing of the camera apparatus 100. On the other hand, when the resolution of the camera apparatus 100 satisfies the preset restriction condition, the exporting circuit 114 exports a geographic area restricted to be photographed by the camera apparatus 100 according to the resolution information of the camera apparatus 100 (S104).

The restriction circuit 116 controls the camera apparatus 100 and the UAV 10 according to the geographic area (S106).

As described above, in one embodiment, according to the resolution of the camera apparatus 100, An area where the camera apparatus 100 can photograph, an area where an image photographed by the camera apparatus 100 can be stored, or an area where the UAV 10 can fly may be set. According to the resolution of the camera apparatus 100, A photographing restriction area of the camera apparatus 100 may be more appropriately set, thereby improving convenience of the UAV 10 equipped with the camera apparatus 100.

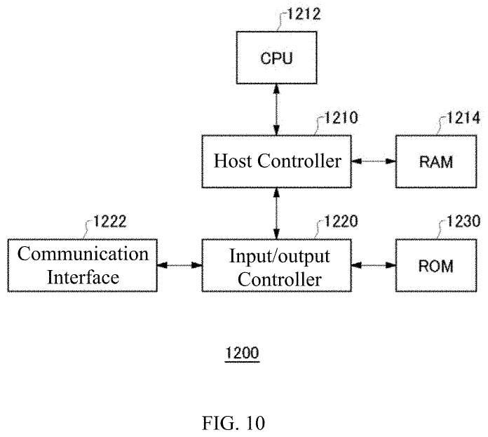

FIG. 10 shows an exemplary computer 1200 that may fully or partially embody various modes of the present disclosure. A program installed on the computer 1200 may make the computer 1200 function as an operation associated with a control device according to one embodiment of the present disclosure or function as one or more “parts” of the control device. Alternatively, the program may cause the computer 1200 to perform the operation or the one or more “parts”. The program enables the computer 1200 to execute a process or stages of the process involved in the embodiment. The program may be executed by a CPU 1212, so that the computer 1200 may perform specific operations associated with some or all of blocks in a flowchart or a block diagram described in the specification.

In one embodiment, the computer 1200 includes a CPU 1212 and a RAM 1214, which are connected to each other through a host controller 1210. The computer 1200 also includes a communication interface 1222, an input/output unit, which are connected to the host controller 1210 through an input/output controller 1220. The computer 1200 also includes a ROM 1230. According to programs stored in the ROM 1230 and the RAM 1214, the CPU 1212 operates to control each unit.

The communication interface 1222 communicates with other electronic devices through a network. A hard disk drive may store programs and data used by the CPU 1212 in the computer 1200. The ROM 1230 stores boot programs and the like executed by the computer 1200 during operation, and/or programs that depend on hardware of the computer 120. The programs are provided through computer readable recording media such as CR-ROM, USB memory, IC card, or network. The programs are installed in the RAM 1214 or the ROM 1230 which are also exemplary computer-readable recording media and are executed by the CPU 1212. An information processing described in the programs is read by the computer 1200 and brings about a cooperation between the programs and various types of hardware resources described above. The control device or method may be configured by implementing operations or processing of information along with a use of the computer 1200.

For example, when performing a communication between the computer 1200 and an external device, the CPU 1212 may execute communication programs in the RAM 1214, and according to the processing described in the communication programs, instruct the communication interface 1222 to perform a communication processing. Under a control of the CPU 1212, the communication interface 1222 reads transmission data stored in a transmission buffer provided in a recording medium such as the RAM 1214 or a USB memory, and transmits the read transmission data to a network or write the received data received from the network into a receiving buffer provided in a recording medium or the like.

In addition, the CPU 1212 may make the RAM 1214 read all or required parts of files or databases stored in an external recording medium such as a USB memory, and perform various types of processing on data on the RAM 1214. The CPU 1212 may write the processed data back to the external recording medium.

Various types of information such as various types of programs, data, tables and databases may be stored in the recording medium, and the information may be processed. For the data read from the RAM 1214, the CPU 1212 may perform various types of processing described in the disclosure, including various types of operations, information processing, conditional judgments, conditional transitions, unconditional transitions, retrieval/replacement of information, and other types of processing specified by an instruction sequence of a program, and write results back to the RAM 1214. In addition, the CPU 1212 may retrieve information in files, databases, and the like in the recording medium. For example, when storing a plurality of entries having attribute values of first attributes respectively associated with attribute values of second attributes in the recording medium, the CPU 1212 may retrieve from the plurality of entries an entry that matches a condition that specifies an attribute value of a first attribute, and read an attribute value of a second attribute stored in the entry, thereby obtaining the attribute value of the second attribute associated with the first attribute that meets the predetermined condition.

The programs or software modules described above can be stored on the computer 1200 or on a computer-readable storage medium near the computer 1200. In addition, a recording medium such as a hard disk or RAM provided in a server system connected to a dedicated communication network or the Internet can be used as a computer-readable storage medium, thereby providing programs to the computer 1200 through the network.

It should be noted that, as long as there is no special indication of “before”, “in advance”, and the like, and as long as an output of a previous processing is not used in a subsequent processing, an execution order of actions, sequences, steps, and stages of the devices, systems, programs, and methods shown in the claims, the specification, and the accompanying drawings in the specification can be implemented in any order. Regarding operating procedures in the claims, specification and accompanying drawings, for convenience, “first”, “next” and the like are used for explanation but does not mean that the operation procedures must be implemented in the order.

The present disclosure has been described above using the above embodiments, but the technical scope of the present disclosure is not limited to the scope described in the above embodiments. Those skilled in the art can make various changes or improvements to the above embodiments. It is obvious from the description of the claims that the changes or improvements may be included in the technical scope of the present disclosure.

What is claimed is:

1. A control device, comprising:
a memory; and
a processor coupled to the memory and configured to:
acquire first resolution information of a resolution of a camera device mounted on a movable object;
determine a first geographic area according to the first resolution information; and
control the movable object or the camera device to prevent at least one of: the camera device from photographing in the first geographic area or an image photographed by the camera device in the first geographic area from being stored.

2. The control device according to claim 1, wherein the processor is further configured to keep the first resolution information when the movable object is in the first geographic area.

3. The control device according to claim 1, wherein the processor is further configured to move the movable object outside the first geographic area when the first resolution information is changed.

4. The control device according to claim 3, wherein the processor is further configured to change the first resolution information after the movable object moves outside the first geographic area.

5. The control device according to claim 1, wherein the processor is further configured to display the first geographic area and a no-fly zone on a map.

6. The control device according to claim 1, wherein the processor is further configured to change at least one of a shape of the first geographic area and a size of the first geographic area.

7. The control device according to claim 1, wherein the processor is further configured to control the camera device in the first geographic area based on an altitude of the camera device.

8. The control device according to claim 1, wherein the first resolution information includes at least one of: identification information of the camera device, identification information of a lens unit included in the camera device, a focal length of the lens unit, a zoom magnification of the lens unit, or identification information of an image sensor included in the camera device.

9. The control device according to claim 1, wherein the processor is further configured to:
acquire a geographic position of an object; and
determine the first geographic area according to the first resolution information and information of the object.

10. The control device according to claim 9, wherein the processor is further configured to control the camera device to photograph the object in the first geographic area based on a latitude, a longitude, and an altitude of the camera device.

11. The control device according to claim 10, wherein the object is a building or a partial area of the building.

12. The control device according to claim 9, wherein the first geographic area includes the object.

13. The control device according to claim 9, wherein the first geographic area does not include the object.

14. The control device according to claim 9, wherein the processor is further configured to:
acquire a geographic location of the camera device and a photographing direction of the camera device at the geographic location;
control, according to the geographic location of the camera device and the photographing direction relative to the geographic location of the camera device, the movable object or the camera device, to prevent at least one of: the camera device from photographing the object in the first geographic area or the image including the object photographed by the camera device in the first geographic area from being stored.

15. The control device according to claim 14, wherein the processor is further configured to acquire a viewing angle of the camera device.

16. The control device according to claim 1, wherein the processor is further configured to control the movable object and prohibit the movable object from entering the first geographic area.

17. The control device according to claim 1, wherein the camera device includes a zoom function, and the processor is further configured to control the camera device to restrict a range of zoom magnification available on the camera device in the first geographic area.

18. The control device according to claim 1, wherein the processor is further configured to:
acquire, when a resolution of the camera device mounted on the movable object is changed, second resolution information of the resolution of the camera device;
determine a second geographic area according to the second resolution information; and
control the movable object or the camera device, to prevent at least one of: the camera device from photographing in the second geographic area or to prevent an image photographed by the camera device in the second geographic area from being stored.

19. The control device according to claim 18, wherein the camera device includes a zoom function, and the processor is further configured to:
acquire a first zoom magnification of a lens unit in the camera device;
when the first zoom magnification is changed to a second zoom magnification, acquire the second zoom magnification as the second resolution information; and
determine the first geographic area according to the first zoom magnification and determine the second geographic area according to the second zoom magnification.

20. A control method comprising:
acquiring first resolution information of a resolution of a camera device mounted on a movable object;
determining a first geographic area according to the first resolution information; and
controlling the movable object or the camera device to prevent at least one of: the camera device from photographing in the first geographic area, or an image photographed by the camera device in the first geographic area from being stored.
